(19) United States
(12) Patent Application Publication
(10) Pub. No.: US 2012/0236160 A1
(43) Pub. Date: Sep. 20, 2012

(54) Remote studio management and control

(76) Inventors: Tomas Rezek, Toronto (CA); Damon Haimoff, Brooklyn, NY (US)

(21) Appl. No.: 13/065,142

(22) Filed: Mar. 15, 2011

(51) Int. Cl. H04N 5/222; H04N 5/225

(52) U.S. Cl. 348/207.11; 348/722; 348/E05.022; 348/E05.048

(57) ABSTRACT

An audio video system comprises a video production studio generating a video signal. A studio receives the video signal from the production studio for broadcast propagation, and the receiving studio generates voice control messages for coupling to the video production studio. A remote control panel is coupled via a network to control equipment within the video production studio and to control the voice control messages received by the video production studio from the receiving studio. The video production studio, the studio receiving and the remote control panel each have different geographic locations. The remote control panel is a graphic user interface displayed on a personal computer and generated responsive to an applet received from the equipment within the video production studio.

### FIELD OF THE INVENTION

The present invention relates generally to audio video program production, and more specifically, to a system, method and product providing remote technical management and operational control of a portable, temporary or permanent video production facility

### RELATED ART

Business constraints in the broadcast television industry have dictated significant staffing reductions and the elimination of remotely located news bureaus, sports and financial market reporting venues. In some situations technicians and or camera people have been eliminated and replaced with remotely controlled studio equipment. These remotely controlled studios incorporate audio and video camera systems to facilitate live interviews and reporting. Such live interviews are known as live shots. However, remotely controlled facilities may be limited in features, functionality and operational capability and prove challenging for non-technical personnel such as production staff or the on camera talent.

### SUMMARY OF THE INVENTION

Both purchase and operating costs may be reduced and operation and control of remote studios simplified by use of applicants remote studio system. The system comprises a remote studio, or audio video source, which includes audio, video and camera systems. This remote studio is coupled to a network server which provides operational enablement, setup, monitoring and maintenance via a wired or wireless network. A broadcast quality audio video programming output from a remote studio is coupled to a broadcast facility, for example internet broadcaster, cable or terrestrial television facility. The broadcast quality signal from the remote studio is included in an internet broadcast (IB) or television broadcast for distribution by wireless, cable, fiber or satellite. The studio equipment may have only minimal local, that is, physical control or monitoring capabilities. Operational control and monitoring is provided by use of a graphic user interface or GUI which is displayed on a personal computer, which for example, may have a desk top or lap top or tablet configuration. The personal computer GUI may be considered a virtual control panel or VCP with which the user can control substantially all functions associated with technical adjustment and operation of the remote studio and the on camera presenter or talent. The personal computer may be located at the remote studio or may be resident at the television studio or broadcast center receiving the remote studio audio video contribution. Furthermore with a broadband connection the personal computer and GUI can control and monitor the audio video systems and talent from any location which has, for example, internet access. Such a remotely controlled studio system may form part of a network of studios coupled to a network server where each studio is accessible and operable via a personal computer. One of a plurality of audio video sources forming a studio network is booked for use. An IP address for the selected audio video source is received by email from server 100, and, when contacted, the audio video source may send an applet, for example an HTML5 file, defining a graphic user interface. The applet is loaded in the computer browser and generates the graphic user interface which facilitates remote control of the audio video source. When the booked studio time has expired all control and monitoring is terminated and the graphic user interface disappears. Alternatively, a proprietary application resident within the personal computer may be launched which generates a graphic user interface. This GUI requests the received IP address in order to initiate contact with the remote studio and facilitate remote control of the studio.

### BRIEF DESCRIPTION OF THE DRAWINGS

FIG. 1 is a block diagram showing current network arrangements of two remote controlled audio video sources.

FIG. 2 is a block diagram showing an inventive arrangement facilitating control of a remote audio video source.

FIG. 3 is a block diagram showing the major functional systems comprising the remote audio video source of FIG. 2.

FIG. 4 shows an inventive graphic user interface display of FIG. 2

FIGS. 4A, B, E, G are larger views of the graphic user interface of FIG. 4

FIGS. 4C, D, F are larger views of the graphic user interface of FIG. 4.

FIG. 5 shows inventive audible communication arrangements between elements of FIG. 2 having different geographic locations.

FIG. 6 is an exemplary control sequence between elements of FIG. 2.

### DETAILED DESCRIPTION

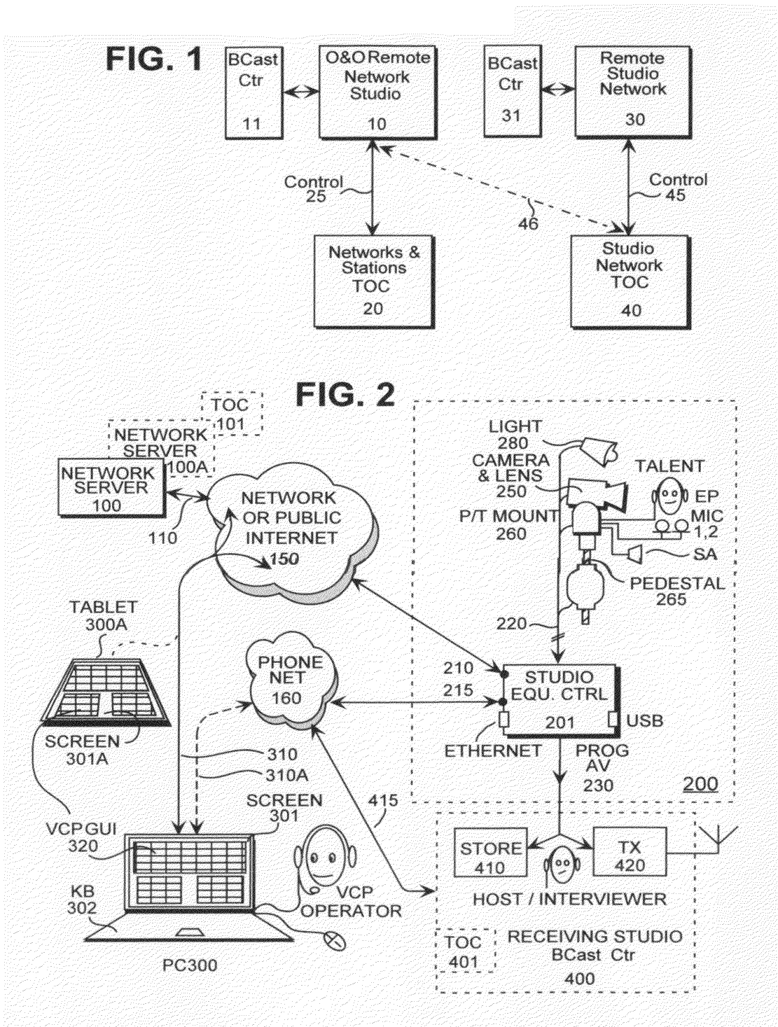

FIG. 1 depicts a current arrangement showing two independent networks each comprising multiple remote studio locations with remote control capability provided from respective technical operations centers. TOC. For example, block 10 represents a remotely controlled exemplary news studio which may be one of a plurality of studios forming a network of studios that are owned and operated by a television network. Similarly block 30 may represent one remote studio also forming part of a network of studios which may be leased or owned by, for example, a financial or sporting organization. The news or interview studio of blocks 10 and 30 include at least one television camera and zoom lens mounted on a controllable pedestal with pan and tilt head. The camera video and presenter (talent), audio or dialogue is coupled to audio video processing equipment which may be controlled to allow levels and transitions to be controlled locally or remotely by signals originating from a technical operations center TOC 20 or 30. An audio video output from the remote studio location is shown coupled to respective broadcast centers 11 and 31 for inclusion in programming for recording or live broadcast distribution via wireless, internet, cable, fiber or satellite. Technical operations center 20 may be designated master with the equipment at studio 10 designated slave and thereby provide control, via connection (25), of remote studio or A/V source (10) by means of fiber, copper, coax, microwave, radio, satellite or the internet (150). The TOC provides full audio, video and camera line up capabilities as is well known. In addition the TOC facilitates the operational control of the remote studio camera or cameras, the studio lighting and presenter audio and director to presenter communication known as interruptible feedback or IFB. Furthermore a technical operations center (20) when configured as a master may be switched to control other remote studios forming a private, possibly world wide, contribution network. Remote studio (30) and TOC (40) are shown with set up, maintenance and supervisory control capability substantially similar to that of remote studio 10 and TOC 20. However, a user or owner of remote studio 30 may not possess technical operations staff hence control of the remote A/V source may be provided via connection 45 from a central technical operations center 40. In addition TOC 40 may provide emergency or maintenance control of remote studio 10 as depicted by control 46 illustrated by a broken line. An example of the exemplary network arrangements of FIG. 1 are available from Media 3 Ltd®, 535, 5th Avenue, New York, N.Y. 10017. Similarly technical operations centers 20 and 40 of FIG. 1 may be provided by the BureauCam® control system which is a registered mark of Media 3Ltd®. The BureauCam® operations manual for models BCS-2500 and BCS-1500 is hereby incorporated by reference.

Applicants' inventive arrangement for the remote control of a TV studio facilitating live shots is shown in FIG. 2. The system arrangement of FIG. 2 is similar to that described earlier but shows one remotely controlled studio (200) which, for example, may form part of a private bookable or rentable network. The network of FIG. 2 is controlled by network server 100 which maintains a central data base that keeps track of all scheduled shots for all network studio locations. In addition server 100 facilitates real time monitoring and maintenance of all network studios and systems and generates billings based on actual usage. A network technical operations center TOC 101 is depicted co-located with server 100, however, such a location though desirable is not essential. The technical operations center TOC 101 facilitates network wide monitoring of each remote studio. Exemplary studio 200 and equipment 201 repetitively sends short diagnostic messages to Server 100. These messages encapsulate information about various system parameters, I/O connection, voltages, temperatures, communication diagnostics, for example dial tone presence, video signal voltages, and information regarding operation and presence of microphones, earpieces, loudspeakers etc. These messages are collected by server 100 which in turn generates a status display for the technical operations center TOC 101. In addition, each parameter is compared against a preset threshold and when a threshold is exceeded the status display indicates the location and nature of the anomaly, and depending on severity, server 100 sends an email or SMS text message to the VCP operator and designated service personnel at the TOC. Typically studio talent earpiece problems may be warned by the VCP operator or an automatically generated message which is sent to a studio announce system.

Network server 100 also performs software and firmware updates either throughout the network or on a case by case basis. A redundant or backup network server 100A mirrors the operation of server 100 and may be located at a different geographic location. In addition to network and studio equipment monitoring and control, network server 100 also facilitates bookings of the studios forming the network. The booking process will be described further with reference to personal computer 300 or 300A and virtual control panel VCP 320. Personal computer 300/300A may be a typical home or office computer having a desk top, laptop or tablet configuration and employing either a Macintosh®, PC or any operating system capable of launching and running an internet browser. In addition a broadband network or internet connection is required, however, full operational control can be maintained via a telephone network (POTS) backup modem (222) in the event of an internet failure. Furthermore, applicants' virtual control panel 320 requires that the computer includes a microphone, web browser or proprietary application.

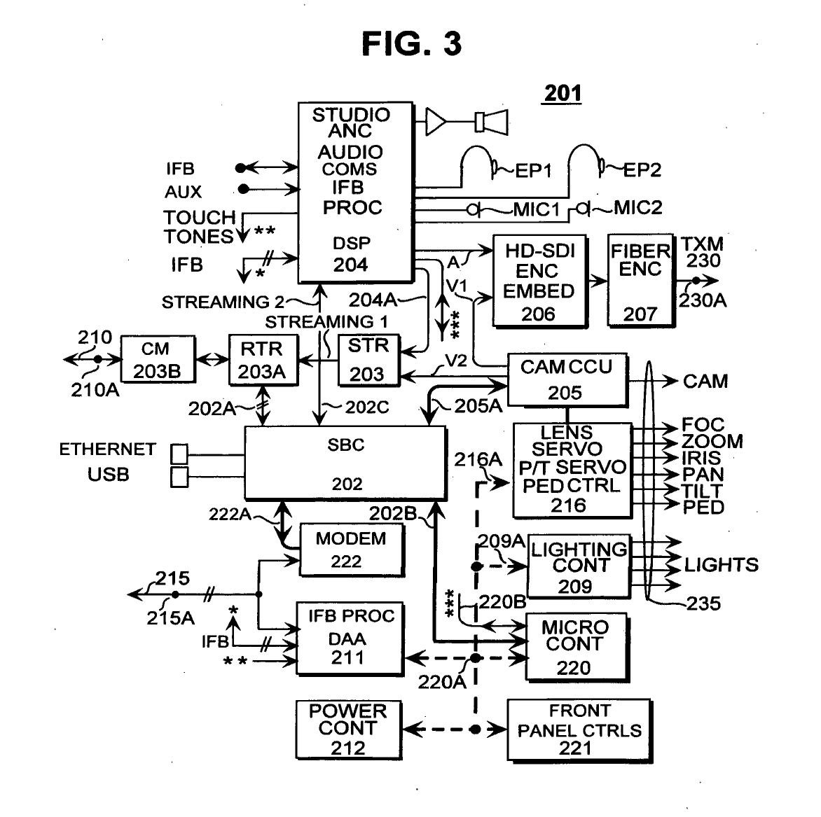

The studio or bureau (200) may be a permanent or temporary installation which houses the system and facilitates the execution of live shots. Stated simply, the bureau is where the talent goes to be interviewed by a remote host. The studio, bureau or audio video source, 200, includes a remote controlled video camera and zoom lens (250) mounted on a remotely controlled pan and tilt head (260). The pan and tilt head is attached to a pedestal 265 which is also remotely controllable to raise or lower the camera height to facilitate seated or standing presenters. Studio 200 also includes a plurality of lights 280 which are individually remotely controllable in intensity. Also included within the studio are audio and communication facilities which are essential to the operation and execution of the live shot. The remote control of these audio and communication facilities, part of 201, is provided by a virtual control panel (VCP 320) displayed on PC 300, and will be described with reference to FIG. 3. Two microphones (MIC. 1, 2) are provided to allow voice etc. from the talent/presenter to be captured for processing and transmission to the exemplary receiving studio 400. Two earpieces (EP1, 2) are provided to permit communication of cues, or questions from the studio destination, or VCP operator to, the talent. This ear piece communication is termed interruptible feedback or IFB. Typically an IFB signal will comprise program sound from the receiving studio destination (400) which is interrupted by the program director's cues and comments. The IFB signal is supplied to the talent, for example to enable cuing or for an interviewer to pose questions, however, this program sound feed does not include the talent's own dialog in order to prevent acoustic feed back or howlround, echoes, or distraction to the talent. This form of IFB audio feed is known as mix minus.

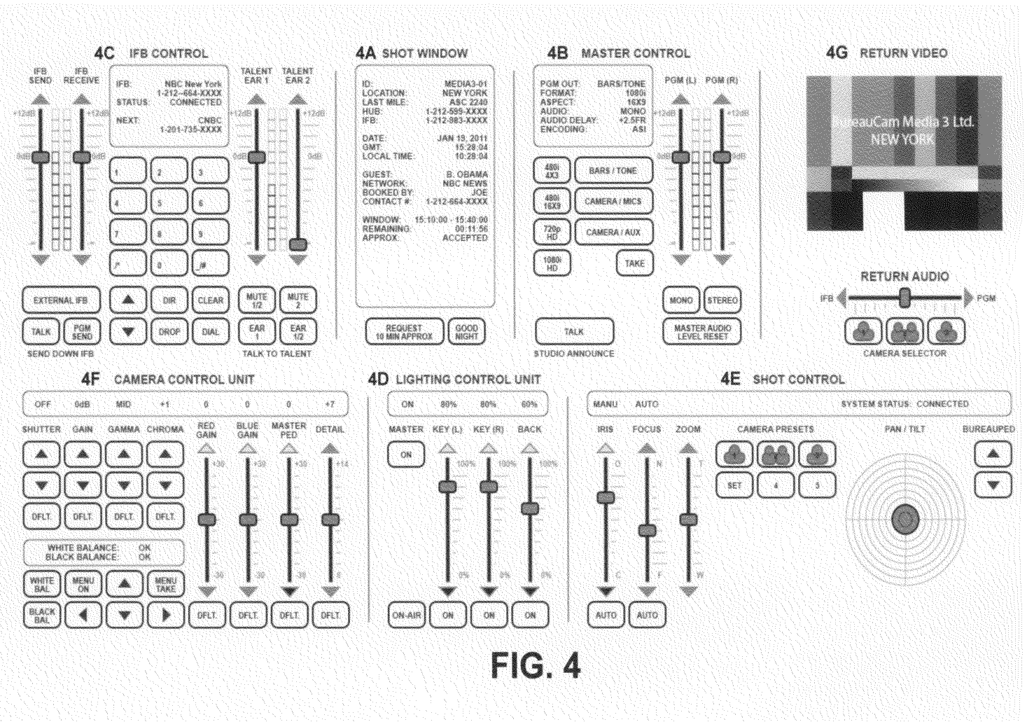

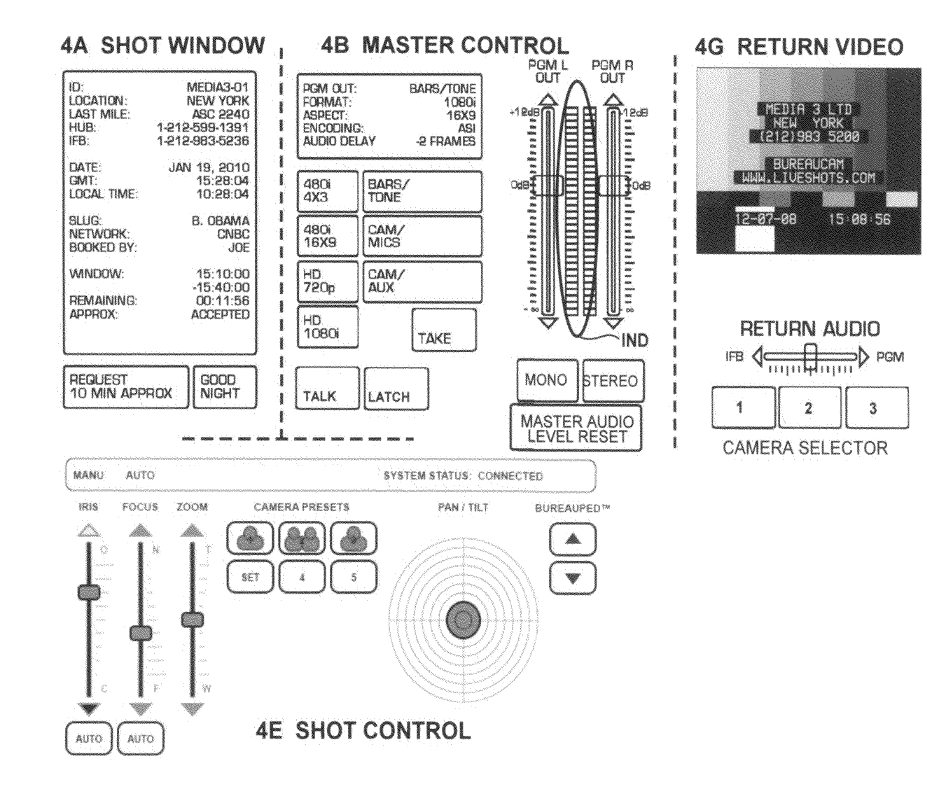

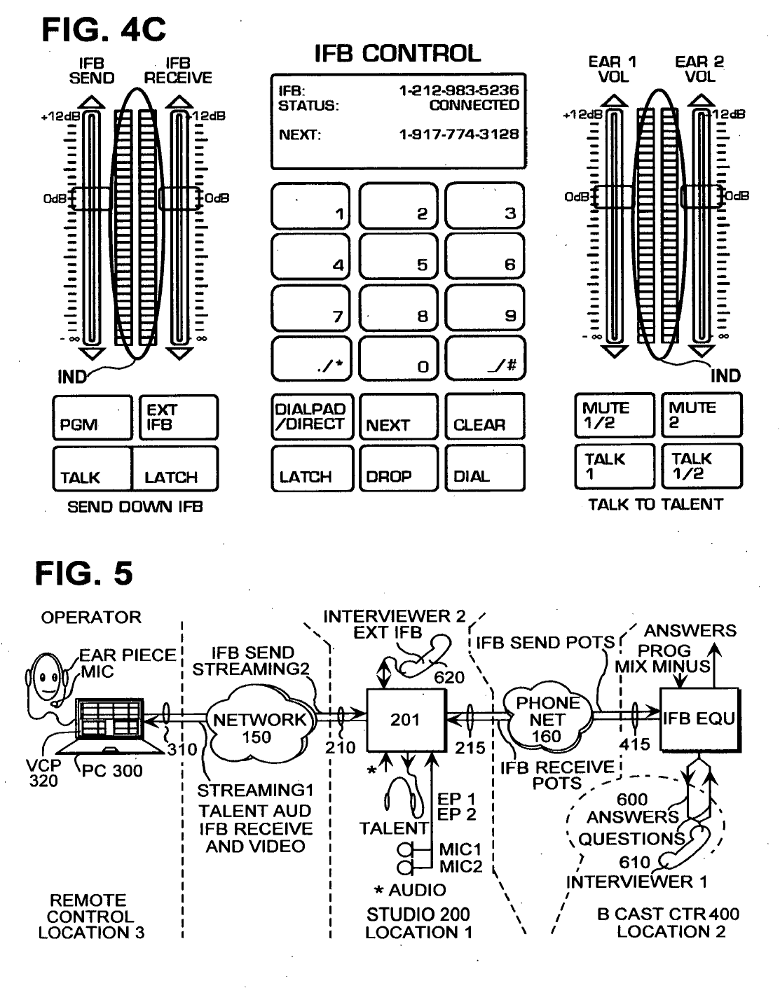

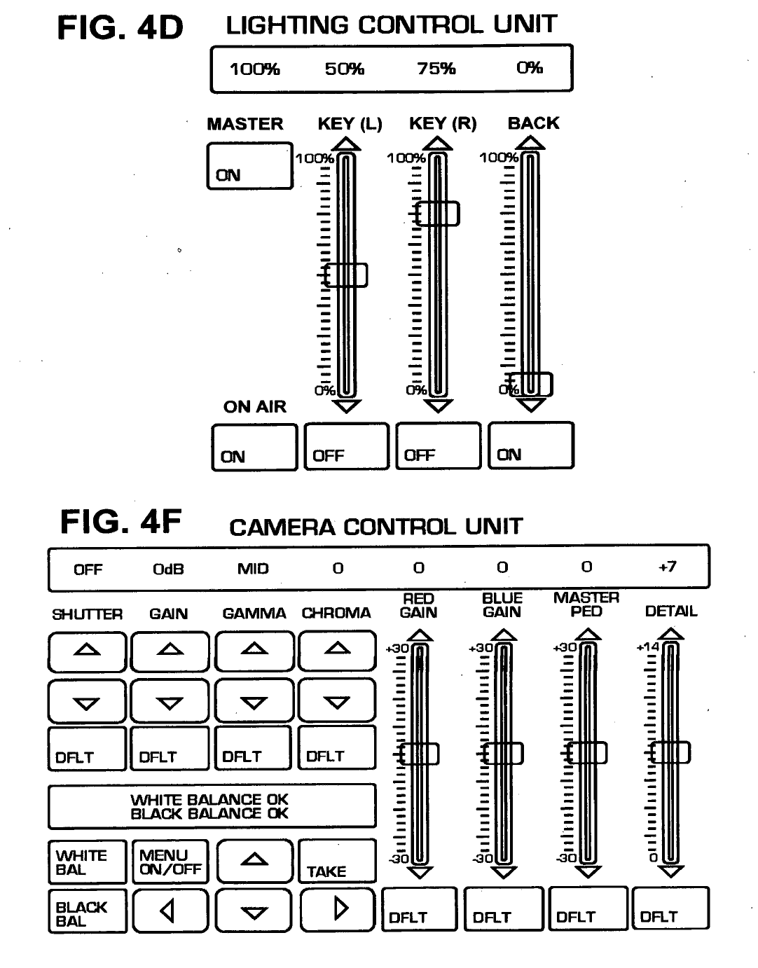

The virtual control panel provided by GUI 320 of PC 300 provides significant IFB control capability. For example, the GUI permits the VCP operator to control and establish telephone connections, the operator may interrupt the studio IFB feed to provide additional talent direction. In addition the VCP operator may mute the IFB fed to the talent, or adjust IFB signal amplitude. Advantageously the GUI can control a mix or balance between the studio 200 program output, typically the talent's microphone and the RECEIVED IFB from broadcast center 400. These IFB control features will be discussed further with reference to FIG. 4C and FIG. 5. A further feature controllably activated from the VCP is a studio 200 announce loud speaker system which allows audible communication from either virtual control panel 320 or receiving studio 400 to be heard by the talent in studio 200, which is useful when an earpiece is defective or missing. The remote control of audio, video, communication equipment is depicted in block 201 and is described with regard to FIG. 3.

The functions and features of studio 200 are provided by remote controlled studio equipment 201 of in FIG. 3. Although FIG. 3 shows functional blocks, these features may, as is well known, be facilitated by analog or digital hardware or a combination of analog and digital hard ware and software. Equipment 201 provides the necessary interfaces to permit bi-directional communication as depicted by arrow 210 at terminal 210A and transmitted by, for example, a private network, Ethernet, USB or public internet 150. Telephone and backup modem communication to and from studio 200 is depicted by arrow 215 coupled via terminal 215A to telephone network 160, for example, POTS, Cell, SAT or VoIP. The transmission of program audio and video TXM via terminal 230A and is facilitated by means of exemplary fiber, however, copper, coax, microwave, radio, satellite and the like are equally applicable for transmission from studio 200 to receiving studio 400. An important aspect in the remote control of studio 200 and equipment 201 is the production of broadcast quality, wide screen high definition pictures and comparable quality sound, whilst under remote control from exemplary virtual control panel VCP 320. Clearly, studio control from VCP 320 requires that in addition to control parameter feed back, the studio audio video (A/V) outputs are also available on the VCP for monitoring by the operator. Thus, studio 200 and equipment 201 produces two audio video outputs, the first, or program output (TXM 230), is a high definition video signal together with a corresponding quality audio signal. The second audio video output (STREAMING 1) which is provided for operator monitoring and control at the virtual control panel VCP 320. However, this output video signal monitoring signal requires processing such as, scaling, down sampling, filtering etc. to facilitate transmission, for example by streaming and for display by VCP 320. Furthermore the audio component of the second output is advantageously mixed, added or summed with the studio IFB signal in response to the VCP operator's requirements. This controllable monitoring mix of audio and IFB will be discussed with regard to FIG. 4G and FIG. 5.

In addition, equipment 201 supports shot booking and system management control, studio lighting control, camera and lens servo control, camera head pan/tilt and pedestal control. Furthermore studio equipment 201 must provide the basic requirements of audio routing, switching or selection, mixing, and embedding, video routing, switching, mixing, scaling and encoding and streaming, plus audio, video and system monitoring. This multiplicity of functions are provided largely by digital hard and soft ware housed in a comparatively small equipment enclosure which includes assignable front panel controls and indicators which will be described. However, substantially all operational, set up and maintenance control is facilitated by means of exemplary personal computer 300 and VCP 320. Personal computer 300 can be collocated with equipment controller 201, or may be adjacent or within the same building and employ a USB or Ethernet connection. In fact, PC 300 can be at any geographic location having public or private broadband connectivity.

A receiving studio and broadcast center is represented by block 400. A live shot or video interview may be broadcast live, as depicted by the arrow pointing to block 420 which represents the transmission system within the broadcast center and the necessary broadcast dissemination means, for example internet connection, transmitter, satellite uplink or fiber terminal. However, such live broadcasts have the potential for on air problems which may be avoided by prerecording or storing the live shot as depicted by block 410. Typically the live shot audio and video is received and stored for editorial review, possible editing and subsequent broadcast transmission via block 420. Furthermore the talent at the bureau may be interviewed by an anchor man or host at the receiving studio in order to provide continuity particularly when the live shot is stored for inclusion in a later broadcast. Program audio and production communication or IFB from broadcast center 400 is available for transmission to studio 200 via telephone network 160 and connection 415. Typically a broadcast center represents the technical center of a contributing network of remote studios and usually will include a technical operations center, for example TOC 401. The TOC provides technical monitoring of the studios. However, engineering and operational control of the remote studio is advantageously facilitated by exemplary virtual control panel 320 and GUI display. Computer 300 and VCP 320 may be physically located at the broadcast center 400, studio 200 or at any location with broadband connection capability.

The remotely controlled studio 200 of FIG. 2 may be booked from computer 300 via a private network or public internet 150 by logging into the secure web site of server 100. Booking information such as broadcaster name, billing information, production name, date of shoot, shoot window or time, guest requirements, etc. are entered into a database of server 100. Once approved, server 100 uploads the booking information via secure FTP (SFTP) to the selected remote studio location where it is stored on a single board computer SBC 202 which maintains a booking schedule for that location. In addition to the booking information, for example date, time, duration, etc the secure FTP message also contains a unique password or key which allows authorized access by the booked user to the selected studio during the booked shoot time window.

A confirmation email is sent to the user/operator by network server 100. The email includes the shoot information, the IP address for the studio and a unique password to facilitate access by exemplary computer 300 to studio 200. The password is only active during the booked shot time window and is invalid for times other than booked. Hence access to the desired studio system is denied outside the shoot time window, furthermore, upon expiration of the booked time, control by VCP 320 is terminated, the return A/V monitoring signals extinguished and the VCP GUI inactivated.

The user/operator uses the furnished password to log on to exemplary studio 200, and this results in a web server, resident within equipment 201, serving an applet to computer 300 or tablet 300A. In the alternative arrangement, the proprietary application previously loaded on PC 300 is invoked and the studio contacted using the emailed IP address and password. The proprietary application, may for example be software be operable with the Android and iOS platforms. However, either the web browser and applet, or resident proprietary application generate a virtual control panel (VCP) in the form of a graphic user interface or GUI (GUI 320) which is displayed on screen 301/301A. In addition the applet or app. facilitates audio streaming (STREAMING 2) from PC 300 to remote studio 200.

The virtual control panel provided by the graphic user interface 320 allows operator monitoring and control of all functions relating to studio 200. FIG. 4 shows an exemplary GUI 320 which provides complete functional control and monitoring of studio 200 by, for example, use of the computer key board KB 301, touch screen 301, scratch pad, track ball, mouse or the like. The use of graphical user interfaces is widely known from the user interface found in personal computers, ATMs etc. A graphical user interface or GUI is an interface that allows human interaction with a computer program by means other than typing textual acronyms. Typically a GUI offers a graphical icon or visual indicator which represents a function, information or action available for user selection. A function or action is selected by direct manipulation of the graphical icon by use of a mouse, trackball or touch-pad or the like to move an on screen cursor or pointer, to or on top of the icon to select and or control the represented function. When the cursor is positioned, software controlling and forming the GUI, detects the cursor position within a mapped screen area which is related to a specific control function. Movement of the cursor or mouse wheel then causes generation of a control value specific to the selected function.

The block diagram of FIG. 3 shows the major functional components and interconnections forming remote controlled studio 200 and equipment 201 located therein. It is to be noted that the audio video outputs are facilitated by HD-SDI encoder 206 and fiber encoder 207 and video streamer 203, and although essential to the operation of studio 200 may not be specifically integrated within equipment unit 201. These system blocks, for example, the HD program signal output format is determined by the requirement to interface with the type of circuit, i.e. “the last mile” installed by the telecommunications provider. Similarly the HD encoding standard provided by encoder 207 will generally be determined by equipment at the receiving destination (400). The video streamer 203 provides a monitoring feed of audio and video for the VCP operator and since video streaming is an evolving technology, streamer 203 may not be integrated within equipment 201. Audio communication from PC 300 is provided by signal streaming 2 and will be explained further with reference to FIG. 5.

Overall control of the studio and equipment is facilitated by a central processing unit formed by a single board computer SBC 202 of FIG. 3, which for example, employs an embedded Advanced RISC Machine (ARM) computer running a Linux operating system. The single board computer provides various interfacing services, for example, to the world wide web (WWW), secure file transfer protocol (SFTP) for software updating, secure shell (SSH) for data exchange during maintenance and, Point-to-Point Protocol (PPP) used for backup or an alternative remote control via modem 222 and telephone network (160). The single board computer or CPU also directly controls camera 205 via an RS 422 link (205A) and communicates with microcontroller 220 and modem 222 using separate TTL UART signaling, data streams 202B and 222A respectively. In addition to the Linux operating system, several custom processes are run on SBC 202 to provide high level control of certain studio components. For example, video camera (205) may be sourced from various manufacturers, however, in view of the sophistication and complexity of software forming the VCP it is essential that this VCP software, and hence the panel's look and feel remain the same regardless of the camera and equipment used in the studio. Thus different camera control and equipment requirements are accommodated by instruction translation provided by the single board computer. Hence a generic virtual control panel (VCP) with a consistent appearance and control is presented on any personal computer (PC 300) used to control and operate any remote studio (200) regardless of the equipment complement. Similarly SBC 202 may be required to interface the camera lens and remote controlled pan and tilt head which may form part of a camera control protocol or may be separately sourced from different manufacturers.

In order to achieve smooth and responsive control, the single board computer (SBC 202) runs several independent processes. These independent processes are necessary to ensure that any internet delays or blocking calls, for example a denial of service attack on one interface will not affect communication on another interface. These processes are independent of each other and only communicate via shared memory (SM) as defined in the POSIX (IEEE 1003) related standards. Memory access with POSIX employs what are known as binary semaphores with values 1 and 0 indicating that memory access is available or unavailable.

A remote communication process deals will all control traffic to and from PC 300 and GUI 320, it also handles all internet 150 traffic, checks for validity of messages, handles authentication related to traffic from PC 300 and GUI 320 and passes the results in binary form to the administration process. The remote communication process is also responsible for modem 222 administration, via TTL UART data buss 222A. Modem 222 provides redundant control capability and, most importantly disturbance free assumption of control in the eventuality of an internet 150 outage.

A hardware communication process, within SBC 202 communicates via TTL UART bus 202B with microcontroller 220, for example a Complicated Instruction Set Computer (CISC) type M16C, manufactured by Renesas Electronics Corporation. Microcontroller 220 provides control information at system start up and then defaults to control by the single board computer SBC 202. This control arrangement provides fault tolerance and advantageously permits control reversion to micro 220 with undisturbed shot continuity in the event of SBC 202 rebooting. When SBC 202 restarts it resumes operational control and invisibly acquires control from microcontroller 220. In addition micro 220 provides control of audio and communications DSP 204 and communicates with dimmer 209 using DMX512 lighting control protocol. All hardware related information is handled by the hardware communication process.

Camera communication process are provided by single board computer SBC 202 which communicates with the camera 250 via data bus 205A using a camera specific communication protocol, for example RS 422. As mentioned previously the single board computer translates generic camera control instructions from the VCP into the protocol required by the camera type and, in addition implements a state machine which orders commands to the camera to establish proper operational sequences. For example, the VCP may request a particular high level camera function, however, this function must be translated into camera specific control actions. One such high level command is for example black balance which requires translation into several camera control actions, for example, cap the camera lens, controllably adjust black levels in each color channel, measure and adjust to achieve a common value then terminate the action. Clearly, during execution of this multi step function other control requests are reviewed for potential conflicts with the current control sequence execution. The camera communication process also handles camera status and errors reports, and attempts recovery from errors, for example, by repeating commands previously rejected, such as conflicting commands received during execution of a prior command.

The camera communication protocol generally permits commands to be transmitted and actioned one at the time. However, there are occasions where it is necessary to transfer multiple commands at substantially the same time, for example, when default values are restored, etc. In addition, different commands have different priorities within the camera which necessitates the command sequencing state machine. This state machine is optimized for responsive remote control, but is largely determined by the control priorities of the camera. All camera control commands are placed in an input queue where a search performed for each new command. A duplicated command results in the older, prior unactioned command being overwritten. This arrangement eliminates unnecessary multiple adjustments and ensures that the queue size is minimized such that the maximum queue size can never be greater than the maximum number of functions controllable within the camera.

The commands are taken from the queue based on a predefined camera control priority, however, the actual read priority of each command may be dynamically adjusted as necessary. For example, if a high priority zoom command exists in the queue the state machine allows only one lower priority command to be executed before attending to the high priority command. However, if multiple high priority commands exist in the queue, the state machine ensures that lower priority commands are still executed, but less often. The overall result is that high priority commands such as VCP joystick movements appear very responsive and low priority commands, such as master black level are not operationally sluggish whilst higher priority commands are serviced.

The camera response to each command is evaluated and if rejected it is replaced in the queue. Each command includes a rejection counter where rejected commands are repeated a predetermined number of times before the command is declared invalid and removed from the queue. Occasionally, as described for black balance, the camera is not ready to execute the next requested command, but will subsequently, thus most commands are eventually accepted. Typically commands that are consistently rejected most likely result from incompatibility from for example camera firmware up dates, etc. The removal of repeatedly rejected commands from the queue prevents the obstruction of valid command execution.

Each command has a predefined time out and if the camera fails to respond within this period, the command is handled as if rejected by the camera. The time outs are optimized to ensure that lower priority commands cannot block commands with higher priority. Whenever all VCP commands have been executed, the state machine ensures that the queue is populated with commands that verify communication, establish camera status and operability. This continual communication ensures that camera is frequently monitored. These non-VCP status verifying commands include parameters such as BARS/PICTURE, tally light, iris and focus position requests, etc. During manual focus and iris control, these commands are placed in the queue approximately every second. However, if auto iris or auto focus is selected, the frequency of the commands is increased to ensure that the VCP GUI 320 representation of iris and focus accurately corresponds to the actual settings.

The overall effect of the camera communication protocol is a camera control unit, facilitated by a GUI, that seamlessly executes multiple commands ostensibly at the same time. Thus the VCP operator is able to pan, tilt, zoom, focus and adjust camera features apparently at the same time since, in actuality, these changes only occur in the camera command queue, which is rapidly emptied by the camera state machine based on the camera command priorities. Advantageously the single board computer implementation of the state machine queue can facilitate control and operation of multiple cameras.

A main process provides all high level decisions at high speed and is effectively over all other processes. Information from all interfaces is processed at high level by the main process, all logical decisions are performed, audio volumes determined, etc. This process also continuously creates a report file containing the system status, which is available via SFTP and is continuously used by the administration process. The administration process reads all available status information, translates it to a binary form and sends it to server 100 approximately every 100 msec.

The sound process is independent of the main process and simply receives audio from PC 300 via a dedicated port. An SBC 202 sound card processes the audio from PC 300 and routes it to the audio and communications processor DSP 204 for processing as controllably determined by VCP 320.

During non-operational times studio 200 assumes a low power consumption mode where all power supplies are shut down with the exception of power to microcontroller 220. Micro 220 remains active to enable detection of a phone call to a particular studio 200 number which, with appropriate authentication, will wake up the system.

Microcontroller 220 is the overall supervisor of all hardware components of system 201 and performs following functions. Micro 220 monitors the intelligent components of the system, for example, digital signal processor DSP 204 and SBC 202 which are required to respond to periodic polling by Micro 220. An absent response will cause a reset to be sent to the absentee device by Micro 220 in an attempt to restore a functional status. Other components are simply monitored and their status reported to the SBC 202 for further decision making. This reporting includes information about various system parameters, I/O connection, voltages, temperatures, communication diagnostics, for example the presence of dial tone, output video signal voltages, and information regarding the operation and presence of external components such as microphones, earpieces, loudspeakers etc. As discussed previously micro 220 controls all power supplies to enable a low-power standby mode when studio 200 is not in use. In addition micro 220 controls the telephone on/off hook status, provides ring detection and monitors the line loop current to detect dropped calls.

Studio 200 lighting is remotely controlled from the VCP by use of a DMX lighting control protocol. Micro 220 generates the DMX512 lighting control code which employs RS485 differential signaling. The DMX512 control protocol is timing-critical and consequently is generated via an interrupt driven mechanism. Lighting dimmers 209 receive the DMX512 control data and may be located as depicted in FIG. 3, within equipment block 201, or alternatively may be located adjacent to the studio lights 280.

The front panel controls 221 of equipment 201 are controlled by the micro 220 in conjunction with SBC 202 which determines the functionality of the buttons and the content displayed on an LCD display. Advantageously the front panel controls or soft buttons are Assigned by micro 220 in accordance with the status of single board computer SBC 202. During normal operation the front panel soft buttons do not provide any significant functionality, nor are they required to. However, when SBC 202 is not available for example, during boot up, resetting, troubleshooting or shut down, micro 220 assumes control of equipment 201 and assigns certain functionality to the front panel controls and display. The panel includes a power button which can place the studio in a standby condition, a soft button indicates current system state, menu buttons allow selection of information fed to the LCD display. For example the LCD can display diagnostic messages, audio levels and can be used to set up basic system parameters during installation.

Camera pedestal 265 is controlled by micro 220 which emulates button pushes required to raise or lower the camera for seated or standing presenters. The camera and lens 250, of FIG. 2, are connected via cable 235 to a camera control unit CCU 205 within remote controlled studio equipment 201 of FIG. 3. The camera may, for example, be a high definition broadcast quality robotic camera, such as available from Panasonic® or Sony® which are registered trademarks of the respective corporations. Operational control and set up of camera 250 may be facilitated by an RS 422 control bit stream from SBC 202 to CCU 205. The control bit stream is formed by SBC 202 in response to data received by router 203A and generated responsive to operation of VCP 320. Exemplary camera 250 simultaneously generates two video outputs, one a high definition analog component signal the second an encoded signal, for example, NTSC or PAL. The high definition signal is coupled directly to serial digital interface 206 with the encoded signal being coupled to streamer 203 for example, Ipela™ SNT-EX101 (trade mark of Sony Electronics Inc.). The choice of robotic camera and the features included therein can advantageously simplify signal and control routing in equipment unit 201. For example, camera 250 may include a built in color bar generator, which in addition may support captioning to identify the geographic origin of the camera as shown in FIG. 4G. Furthermore such a camera will permit the remote selection between color bars and camera video. Hence with such an exemplary robotic camera it is possible to simplify signal routing and control within equipment 201. Alternatively burnt in captioning for source identification may be supported by, for example, streamer 203.

The high definition output from camera 250 may be in the form of analog components or a serial digital video bit stream which is applied to an exemplary serial digital interface (HD-SDI) encoder and embedder 206 which if required can serialize the video data into a standardized bit stream, for example, ITU BT.656 or SMPTE 292M. Audio data, for example digitally encoded within digital signal processor DSP 204, but derived from the studio talent's microphone, is also coupled to encoder 206 where it is embedded in the video data bit stream. The standardized audio and video bit stream is then coupled to exemplary optical fiber encoder 207 for transmission to a telecommunication service provider for carriage to the destination studio 400.

Audio and communications processing is performed by digital signal processor DSP 204 which provides a number of audio functions. Clearly the talent's studio microphone requires amplification and similarly a second IFB, or audio input may accept either high or low level input signal levels. Each of the exemplary input signals are encoded to form serial digital bit streams within DSP 204. Audio processing features such as signal amplitude control or signal mixing can be implemented by a digital signal processor DSP 204. The serial digital bit stream from, for example, the talent's microphone may be controllably coupled within DSP 204 to a storage device such as a read write memory. By controllably adjusting the instant of reading a written audio file, it is possible to introduce a time delay or advance, to the timing of the microphone audio relative to the program video. The offset between reading and writing to and from the memory may be preset or advantageously adjusted from the VCP. Such timing adjustment may be used to obviate or diminish visibility of lip sync errors between, for example, spoken words and the corresponding speaker's facial image. Lip sync errors may result from several causes, for example, frequently cameras include digital image processing which can introduce a time offset, or delay, between image generation and a corresponding accompanying sound. Furthermore, image manipulation within the camera, such as a vertical flip, is frequently performed by digital image manipulation with a consequential added picture delay and further loss of lip-sync. Furthermore the use of image processing or compression, such as MPEG, inherently involves greater processing time for the video than that required for an accompanying audio signal. Also differential delay errors can occur between the audio and video during transmission beyond studio 200, and although lip sync errors may be adjusted to be indiscernible at the remote studio, an adjustment known as pre-correction can be facilitated from the VCP. The advantageous correction or pre-correction of lip sync errors may be performed as described by temporal adjustment of the audio signal leaving exemplary DSP 204. In addition digital signal processor DSP 204 generates an analog audio feed which is power amplified to drive a studio announce loud speaker and provide audible contact with persons within studio 200.

Communication or voice control messages between the production staff (interviewer or host) and the talent or presenter is an essential requirement of any interview or live shot. Voice control message communication between the director or production staff to presenter is known as interruptible feedback or IFB. Typically IFB is provided to at least one ear piece in the talent's ear to provide cueing, host's questions or production direction. Usually an IFB audio signal will comprise a program sound signal which probably includes a host's dialog and, as described previously, is known as mix minus. This program audio from the receiving destination 400 is interrupted by voice control messages with production cues and director's comments. Advantageously equipment 201 includes IFB processing by means of a digital signal processor DSP 204, for example, Analog Devices Sharc™ ADSB21262 (trade mark of Analog Devices, Inc). In addition, the same digital signal processor (DSP 204) is used for manipulating the program audio. Although digital signal processor DSP 204 provides routing and processing for both audio and communication signals it has limited intelligence and is controlled by single board computer SBC 202. The single board computer issues routing, mix amount, volume control values, dialing, and lip sink adjustment which may be VCP controlled or preset and specific to camera type. However, although the DSP is of limited intelligence it is fully self-sufficient and continues processing in the event that SBC 202 ceases to respond to polling by micro 220 and is reset. Advantageously, audio and communication functionality continues without interruption regardless of the status of other system components. The functionality of the DSP 204 is also closely monitored by micro 220, which will reset DSP 204 whenever it fails to respond to a periodic poll.

Digital signal processor (DSP 204) performs routing and mixing of all audio, communication (IFB) and telephone signals. The audio, communication (IFB) and telephone signals are digitized and controllably mixed by DSP204 in accordance with control command settings received from VCP 320 via router 203A and single board computer SBC 202. Volume or signal level adjustments values of all audio, communication (IFB) and telephone signals are received from the SBC 202. However, such level changes cannot be directly applied as a single control value step because audible distortion will result. Instead, DSP 204 implements an algorithm which ramps between the current and new control values causing signal levels change smoothly thereby eliminating significant audible distortion.

In addition to signal processing, digital signal processor DSP 204 synthesizes a 1 kHz 0 dBm sine wave which is controllably routed by SBC 202 for reference and lineup purposes. To facilitate telephone dialing DSP 204 also syntheses touch tone DTMF signals for voice-frequency band telephone signaling. In response to VCP 320 control commands, the single board computer SBC 202 initiates a telephone call by causing micro 220 to take the phone line off-hook and pass the desired phone number to DSP 204 for touch tone generation. This sequence ensures the proper timing, frequency and level of the DTMF signals during the dialing. In addition, this dialing process also results in temporarily modifying the signal level feeding the earpiece to prevent dialing tones from disturbing the talent.

A further source of disturbance to not only the talent but also the other parties involved in the communication results from near-end and far-end echo. To circumvent these problems, two unique algorithms are implemented by DSP 204. Near-end echo generally results from coupling or crosstalk in the hybrid circuit arrangement which forms part of data or direct access arrangement DAA 211. Crosstalk cancellation is performed by DSP 204 which buffers the audio sent to DAA 211 and subtracts an appropriate phase-shifted portion from the received signal which significantly reduces the unwanted transmitted audio signal in the received audio signal. However, this technique is only partially effective because different frequency components of the transmitted signal are affected differently within the circuitry of DAA 211. To further reduce these annoying crosstalk artifacts a so called far-end echo reduction is implemented by the use of real time volume adjustment. DSP 204 monitors in real time the volume of the transmitted (SEND IFB) audio signal and reduces the level of the received signal proportionally. This results in an automated quasi half-duplex functionality which eliminates most of the echo. This feature is automatically engaged whenever communication down the phone line is initiated via GUI 320 and measurable audio levels are detected on the transmit line.

A data access arrangement DAA 211 is a single-chip phone line interfaces which provides the necessary electrical isolation and interface features between equipment 201 and an exemplary public switched telephone network or plain old telephone service (POTS) 160. DAA211 is an integrated circuit type CPC 5621, for example manufactured by Litelink™ trade mark of Clare, Inc. Control of IFB signal amplitude and mixing will be described with regard to the virtual control panel of FIG. 4C and system of FIG. 5.

FIG. 4 shows an exemplary virtual control panel 320 which is displayed as a graphic user interface or GUI on screen 301/301A of computer 300/300A. As explained previously VCP 320 is generated in response to an applet served from exemplary single board computer SBC 202, or is formed by a propriety application resident in PC 300. The virtual control panel GUI 320 provides a user/operator with the ability to remotely control and monitor functions relating to the setup and operation of studio 200. Virtual control panel 320 comprises seven display areas that emulate the necessary controls and signal monitoring to execute a remote live shot. These display areas will be described with reference to enlarged views shown in FIGS. 4A-G. It should be remembered that the virtual control panel GUI is soft ware based and may, with minor software changes provide features different from, or in addition to those depicted in FIGS. 4A-G. For example, the size of return video screen (FIG. 4G) my be temporarily enlarged by the operator to provide additional scrutiny. Features such as lip sync adjustment may be hidden from VCP view but may be accessed by, for example, multiple or sustained button pushes or right mouse clicks etc.

Most VCP controls represented on GUI 320 share a common operating principle in that they function as indicators, representing the actual value or state of the controlled parameter within equipment 201. However, when the quiescent setting of the icon or graphical representation is selected by the VCP operator it becomes a control element which communicates a desired change immediately to equipment 201. When manipulation of the graphical element ceases, for example when a mouse pointer is released, the control element reverts to an indicating function after a short interval. Thus, the graphic representations of GUI 320 display the actual, current status of each controlled part of equipment 201.

When a control is moved to new position but the change is rejected by the controlled device, the control representation will, for example, “jump” back or resume its prior state, position and or value when the control is released. Thus the user is informed that the desired change has not been implemented. This functionality is implemented by a flag that is sent with each control command, where the presence of a flag indicates manipulation the control representation. The controlled equipment only “listens” to VCP requests when this flag is set and at all other times equipment 201 continuously reports equipment status and parameter values to VCP 320. All controls and statuses are encoded in simple binary User Datagram Protocol (UDP) packets. The VCP GUI 320, actually PC 300, is the master in this communication scheme and sends packets to equipment 201 continuously, and receives an immediate response with the current status information and parameter values.

Turning to FIG. 4A which shows a panel area titled SHOT WINDOW. This area displays pertinent real time information and status regarding the booked live shot. An exemplary window displays the following:

| | |
|---|---|
| ID | Media 3-01 |
| LOCATION | New York |
| LAST MILE | circuit provider name and ID number |
| HUB | phone number |
| IFB NUMBER | phone number |
| DATE | XXX XX XXXX |
| GMT TIME | XX.XX.XX |
| LOCAL TIME | XX.XX.XX |
| GUEST | interviewee name |
| NETWORK | e.g. NBC, ABC, CBS, CNBC etc. |
| BOOKED BY | J Doe |
| CONTACT | phone number |
| SHOT WINDOW | time and duration of booking |
| REMAINING | count down clock |
| APPROX | status of requested booking extension. |

The time remaining in the booking is important because, as mentioned previously, when expired, all control and connection with the studio is terminated. Hence, if the live shot is likely to over run the booked time it is desirable that a request for an extension of time be generated and approved to prevent disconnection. The display area shows a button image titled REQUEST 10 MIN APPROX which, when selected signals studio 200, where SBC 202 consults the studio booking schedule to determine if a booking extension can be approved or if a conflict exists. A successful request is signaled from the studio SBC 202 and ACCEPTED is displayed in the SHOT WINDOW of VCP 320. In addition the usage extension is signaled to network server 100 for billing purposes. When a live shot is completed within the booked time the studio can be effectively turned off or placed in the quiescent state described earlier by selecting the display button GOOD NIGHT. Selecting GOOD NIGHT terminates control of the studio and causes the studio lighting to slowly dim thereby allowing for the talent to exit.

FIG. 4B shows a panel area titled MASTER CONTROL which indicates the current output signal source, for example color bars or camera video together with the image format and aspect ratio together with the audio encoding standard and audio delay. In addition various button images permit selection between different image standards, for example 480I 4×3, HD 720p or HD 1080i. The MASTER CONTROL area permits selection between vision and audio sources to be transmitted or sent to line. Color bars and audio tone (BARS/TONE) are selected for source identification and line up, with camera video and microphone (CAM/MICS) selected for program transmission. Audio signal switching or routing is performed by DSP 204 and video source selection occurs within exemplary camera 250 as described earlier.

However, the source selected for transmission is not switched to until the TAKE button is activated. This feature is provided for all buttons that have the potential to alter a shot in progress i.e. on air. The TAKE button confirms the action which has been pre-selected by a flashing red perimeter area adjacent to the selected button. The actual on air vision source and video format is identified on the panel display by a yellow boarder surrounding the source and format display graphics.

The MASTER CONTROL area also includes graphical representations of audio level control levers or faders. These two fader images allow the left and right program audio levels to be controlled independently. The audio remote control data stream from PC 300 is coupled via exemplary internet 150 to router 203A then SBC 202 and on via bus 202C to DSP 204 which provides audio processing and gain control. In addition, selection of MASTER AUDIO LEVEL RESET button returns all audio levels to a standard predetermined setting. Also buttons titled MONO and STEREO permit selection of program audio signals between stereo or monaural operation. Located between the graphical faders PGM(L) PGM(R) are two columns captioned IND. These columns provide a real time display audio signal levels occurring in the adjacent transmission audio channels, nominally in volume units (VU). The columns vary in intensity and or height in accordance with peak audio signal levels measured by DSP 204 as dBu values. These values are reported to SBC 202 where they are encoded for packet transmission to the VCP. Thus this audio amplitude display arrangement does not incur the latency inherent in typical streaming arrangements.

Located adjacent to the MASTER AUDIO LEVEL RESET are buttons titled STUDIO ANNOUNCE these two buttons TALK and LATCH allow the VCP operator to speak to the studio via a studio announce loud speaker either momentarily using TALK image or to hold the connection open by using the LATCH image. The VCP operator speech is captured by a head set microphone or a microphone resident in personal computer (PC 300) and streamed to studio 200 via STREAMING 2. Studio announcement by the VCP operator may become necessary when, for example, the talent's ear piece has failed or the talent is leaving the studio.

As mentioned previously, manual lip sync adjustment may be a hidden VCP feature. When accessed, two button images titled AUDIO DELAY allow the program sound, typically the talent's microphone audio, to be adjusted in time such that the spoken audio matches or is in sync with the mouth image. Typically the audio signal must be delayed to eliminate or reduce the visibility of lip sync errors. A button +FRM increments audio delay in steps of one frame whilst button −FRM button decrements the delay one frame per push. Since VCP audio video monitoring (STREAMER 1) is facilitated via streamer 203 any lip sync errors may be corrected for signals leaving studio 200. However, lip sync errors occurring beyond studio 200 require that the VCP operator be located, for example, at the receiving destination where an lip sync error may be viewed and pre-correction applied to anticipate errors occurring in transmission.

Turning now to FIG. 4C which shows an area titled IFB CONTROL. Interruptible feed back or IFB was described with respect to FIG. 2. However, comprehensive control capability is essential to ensure audible communications between all parties involved in a broadcast remote live shot. Typically the receiving studio (400) will initiate a telephone call to establish an IFB circuit to the remote studio (200). Occasionally the remote studio may need to dial into the receiving studio to access to IBF. Advantageously, applicants' IFB CONTROL area functions as an integrated telephone, or dial up device that allows the VCP operator to establish an IFB connection for studio (200). Stated simply, the IFB arrangements of equipment 201 may be considered a telephone with a web interface that is operated remotely from virtual control panel 320. The controls provided by the VCP allow not only the manipulation of IFB signals received from broadcast center 400, but also enables others, who are not physically present at the broadcast center 400 or studio 200, to contribute to the IFB communications.

In addition the IFB CONTROL facilitates the separation of received, incoming questions and sent or transmission of outgoing answers, by means of a novel combination of network streaming and telephone audio circuits. Connections between the often geographically separate components of applicants' remote control arrangements namely, studio (200) at location 1, destination (400) at location 2 and operational control (VCP 320) at location 3 are shown in FIG. 5.

The central portion of FIG. 4C, termed the dial-pad permits either manual or memory dialing. In addition to the graphical representation of a conventional telephone dial pad layout, an alpha numeric display shows the last number dialed and status, for example connected, on-hook etc. In addition, this alpha numeric display also shows the next number, previously stored in memory and available of automatic dialing by toggling the DIAL PAD/DIRECT button image and then selecting the DIAL image. The NEXT button selects the next number stored in the memory and displays it in the alpha numeric display. The CLEAR button removes the number currently displayed as next, the LATCH button holds an established call and DROP disconnects the call. The programmable Directory feature allows the preprogramming, editing, selection and dialing of a series of IFB numbers. This feature is particularly useful in the rapid execution of “Media Tours,” a repetitive, consecutive series of remote studio interviews conducted by different broadcasting companies.

IFB audio levels may be controlled by a graphical representations of audio level control levers or faders titled IFB SEND and IFB RECEIVE. Manipulation of the fader knob image, shown at 0 dB, cause control value data to be sent via the remote control data stream and network connection 310 to digital signal processor (DSP 204) to change the IFB signal gain or amplitude. Located between the graphical faders IFB SEND, IFB RECEIVE are two columns captioned IND. These columns vary in intensity and or height in accordance with the actual real time peak IFB signal amplitude and do not suffer the significant latency inherent in typical streaming arrangements. These real time indicators are responsive to IFB signal levels measured by DSP 204 and continuously sent in data packets to the VCP.

FIG. 5 shows the audio and IFB communication arrangements controlled from PC 300 using VCP 320. However, it should be remembered that PC 300 is connected to studio (200) and broadcast center (400) by means of broad band network 150 only. Modem coupling via telephone network 160 may provide a backup connection during an outage of network 150. As explained previously the IFB signal originates from IFB equipment (IFB EQU) at broadcast center (400) and is typically sourced to, or accessed by the remote studio (200) by means of telephone dialup via, for example POTS. However, control and monitoring by the VCP operator at location 3 requires that the IFB signal from broadcast center 400 (location 2) is made available at the PC 300 location. Advantageously IFB control and monitoring at VCP 320 is facilitated by means of streaming (STREAMING 1) via network connection 310. The VCP operator audio (voice) is streamed (STREAMING 2) from PC 300 to form a second IFB signal, termed IFB SEND as will be explained. Four graphical buttons titled SEND DOWN IFB allow VCP operator selection of signals to be sent to the talent and beyond via the IFB SEND system. Typically an IFB channel is simplex or unidirectional from the broadcast center to the remote studio. However, the IFB CONTROL provided by VCP 320 advantageously facilitates a novel duplex connection of IFB signals using streaming via network (150) and phone network (POTS 160).

The virtual control panel (320) controllably facilitates the additional of other local, studio 200, audio signals to the RECEVE IFB signal emanating from broadcast center 400. The combination of these additional signals contribute to the IFB SEND signal. For example, the VCP operator can insert instruction or comment into the RECEVE IFB signal sent to the studio 200 talent. In addition the VCP operator can send the program output from studio 200, typically the talent audio, to the IFB SEND circuit.

A first button labeled SEND PGM allows the audio program output from studio 200, typically the talent's audio, to be sent forming the IFB SEND signal. However, as will be explained with regard to FIG. 4G, VCP 320 also advantageously facilitates a mix between the RECEVE IFB and studio 200 program output. Although the use of streaming technology permits duplex IFB operation, during typical operational conditions the IFB SEND signal is not frequently required. A second button labeled EXT WB permits the connection of a telephone call from for example, POTS, CELL, SAT, or VOW, to studio 200, or enables a studio audio signal source to contribute to the IFB SEND signal.

The IFB SEND signal can be provided to an exemplary remote field producer or interviewer who may not be physically present at either studio 200 or destination studio 400. Such a remote interviewer is illustrated in FIG. 5 by the telephone hand set 610 of element 600, shown coupled into broadcast center 400. However, a remote interviewer may be located anywhere that telephone communication is possible. Furthermore the connection may be established by the interviewer calling either broadcast center 400 or remote studio 200. Advantageously the VCP 320 dial-pad, of FIG. 4C, allows the VCP operator to initiate dialing and establish a telephone connection between a remote interviewer, represented by example phone hand set 620 of FIG. 5, and studio 200.

A graphical fader titled IFB SEND allows VCP control of the signal amplitude of the IFB SEND signal. Similarly, the graphical image titled IFB RECEIVE provides fader like control of the RECEVE IFB signal amplitude.

As stated previously, FIG. 5 shows that PC 300 is connected bidirectionally to studio 200 by streaming signals via broad band network 150, with WB communication beyond studio 200 to, for example, broadcast center 400 and elsewhere, provided by telephone network 160. Advantageously the VCP operator may communicate exclusively with talent in studio 200, or with the talent and the IFB network or exclusively the IFB network as will be explained.

Two further graphical buttons permit speech from the VCP operator to be added momentarily to the IFB SEND by selecting TALK or added continuously by selecting LATCH. Thus use of IFB SEND feature streams VCP operator speech and control to studio 200 where the IFB SEND signal is interrupted by the operators comment. However, VCP communication intended for production staff only and not the studio talent can be achieved by selecting MUTE 1/2 or MUTE 2 which mutes IFB signals to the talent's respective earpieces. Once the IFB connections are made, the VCP operator can communicate with the remote studio by two different signal paths. A first path is as previously described, where the VCP operator comments are added to the IFB signal which propagates system wide via STREAMING 2 and POTS 160. A second communication path also via STREAMING 2 controllably allows the VCP operator to talk exclusively with the talent by use of graphical buttons titled TALK TO TALENT. The VCP operator talks via the earpiece signals to both ears TALK 1/2 or one ear TALK 1. The VCP operator may selectively mute one or both earpiece signals with buttons MUTE 1/2, MUTE 2. The ability to mute signals supplied to the talent's earpieces is particularly useful in situations when the IFB signal lacks the usual mix minus format. Under such conditions talent confusion results from hearing his own voice, probably delayed in time. Advantageously the earpiece muting capability allows the VCP operator to mute the IFB signal fed to the talent's ears during his dialog thereby obviating any disturbance. However, real time monitoring of the IFB RECEIVE signal at the VCP allows the operator to un-mute the earpieces when questions etc are posed via the IFB. Furthermore independent adjustment, via DSP 204, of the earpiece volume level is provided by audio control lever graphics titled TALENT EAR 1 and TALENT EAR 2. Located between the graphical faders are two columns, captioned IND, which display in real time the signal level supplied to each ear piece.

The IFB CONTROL GUI facilitates operator control and monitoring of various exemplary signals shown with respective communication paths in the following table.

| SOURCE/DESTINATION | COMMUNICATION PATH |
|---|---|
| studio 400 to remote studio 200 EAR 1 | via dial-up over POTS, CELL, |
| | SAT, VOIP |
| studio 400 to remote studio 200 EAR 2 | via dial-up over POTS, CELL, |
| | SAT, VOIP |
| remote studio 200 to studio 400 | via dial-up over POTS, CELL, |
| | SAT, VOIP |
| studio 400 to VCP | via dial-up and streaming 1 |
| VCP to studio 400 | via streaming 2 and dial-up |
| VCP to studio 200 EP 1 | via streaming 2 |
| VCP to studio 200 EP 2 | via streaming 2 |
| VCP to studio200 announce | via streaming 2 |

The virtual control panel provides monitoring of the program video, audio and IFB in the display area titled RETURN VIDEO in FIG. 4G. The return audio and video signals are generated by video streamer 203, which is part of unit 201, and streamed as STREAMING 1 to PC 300 for monitoring and display. Studio 200 output program video signal is displayed on VCP 320 and FIG. 4G shows an exemplary identified color bar image which includes the studio name, location, telephone number plus date and time. In addition to displaying the studio output video signal, the streamed video feed to the VCP may include, at the top and bottom screen image edges, superimposed or added information identifying for example, the studio location, streaming bit rate etc.

Three graphical buttons titled CAMERA SELECTOR provide the VCP operator the ability to monitor an exemplary group of three cameras. The buttons are labeled 1 to 3 and in addition include an icon depicting the framing of shots preset for each camera. As already mentioned, the virtual control panel GUI is soft ware based and minor feature changes may be facilitated with changes to the GUI software. For example, FIG. 4G shows a CAMERA SELECTOR with three graphical camera representations, however in the exemplary arrangement shown in FIG. 2 only a single camera is employed hence the CAMERA SELECTOR may be absent from a VCP controlling studio 200 of FIG. 2.

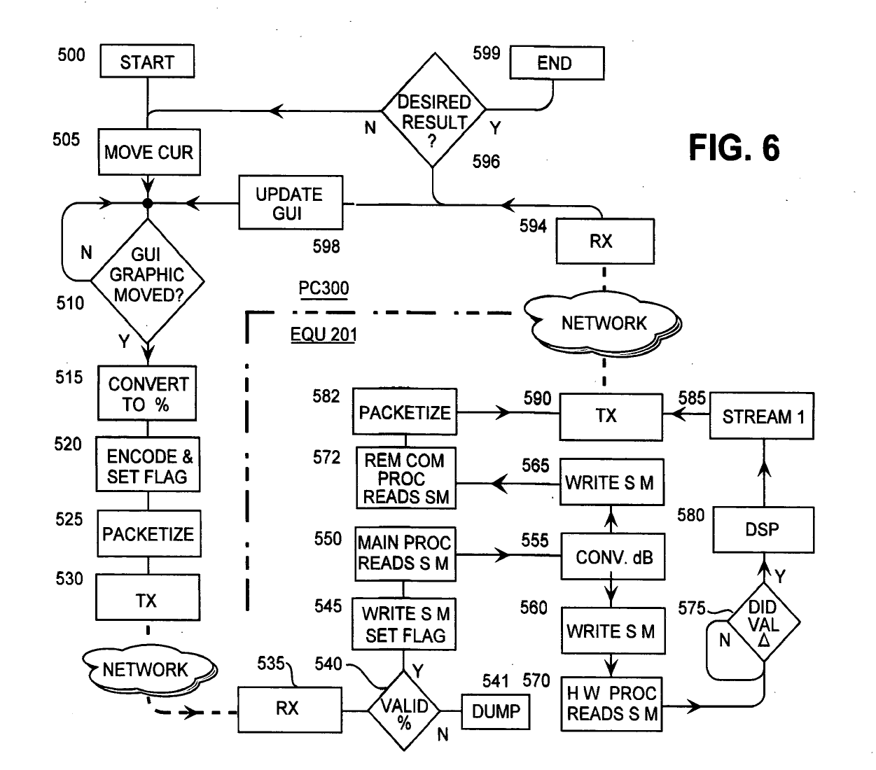

The RETURN VIDEO area includes a graphical fader titled RETURN AUDIO which advantageously facilitates VCP operator control of a mix between RECEIVE IFB audio and program audio from studio 200. With the graphical fader knob in the center position, equal amounts of RECEIVE IFB and program audio are available for coupling to SEND IFB by selecting button SEND PGM. Moving the graphical fader knob towards either end increases the contribution of the signal labeled at the fader end. This controlled audio mixture is formed within equipment 201 by a DSP 204 and is coupled to streamer 1 (STR 203) for transmission to the VCP. The streamed mix of the RECEIVE IFB (host's questions) and program audio (talent's answers) allows the VCP operator to monitor the combined question and answer, and, via the SEND PGM button enable a remote producer or interviewer, located anywhere with phone connectivity, to conduct or participate in the live shot. However, this controllable mix can result in difficulties for the talent who will hear his own voice in his ear piece. This potential problem, known as side tone, is largely obviated by IFB processing by DSP 204 which subtracts the talent's voice (program output) from the IFB SEND signal and effectively creates a mix minus signal for the talent's earpieces. A control sequence related to the mix feature of the graphical RETURN AUDIO fader is described in detail and shown with reference to FIG. 6.

Turning now to FIGS. 4D, E and F which generally relate to the camera, lighting and lens control aspects of the live shot. FIG. 4D is titled LIGHTING CONTROL UNIT and provides operator control, via a DMX512 protocol, of three channels of studio lighting control plus a fourth channel which activates an “ON-AIR” light whenever camera video is selected for transmission. Each illumination source, or luminaire may be controlled by selection of the graphical fader where a percentage value indicative of intensity is indicated above the fader. In addition each lamp may be turned on or extinguished by selecting the ON/OFF button at the bottom of each fader. A graphical button titled MASTER provides for the simultaneous control of all lights once their respective intensities have been set. The three channels are named according to a typical simple set arrangement.

FIG. 4E shows the SHOT CONTROL graphic area which includes CAMERA PRESETS and PAN/TILT and PEDESTAL controls. Lens focus and iris can be controlled manually or automatically by selecting the appropriate AUTO button. Above the graphic slider controls for IRIS and FOCUS are indicators which show the control status i.e. manual or auto. The automatic mode relieves the VCP operator of the need to continuously monitor lens focus and iris or camera exposure. However, the zoom function is an aesthetic control which determines picture content size and as such is not automated. The PAN/TILT control is a graphical display of a conventional joy stick. Movement of the graphical knob to the left or right causes the camera and head to be panned or moved from side to side. The camera may be tilted up or down by moving the graphical knob towards or away from the operator. Typically a live shot will require only a few different camera positions or lens angles, and these may be manually determined and stored in five sequential memories by selecting SET. Selection between the stored camera positions is achieved by selecting the appropriate RECALL button. However, to assist the VCP operator the graphical buttons include an icon depicting the framing or camera angle provided by the preset values. The camera height is controlled by use of the PEDESTAL up down arrow buttons. The pedestal height, tilt and lens zoom controls are used in conjunction to produce aesthetically pleasing shots of talent with a range of different heights, seated or standing. A graphic titled PRESET SPEED allows the operator to control the speed or rate at which the camera changes between preset camera positions or lens angles.

The CAMERA CONTROL UNIT or CCU panel area is shown in FIG. 4F. The CCU section allows remote operation of the camera's control, setup or alignment features. Typically the remote studio conditions are stable and consistent thus many of these camera parameter adjustment features may remain in the default DFLT condition. However, to provide optimum image fidelity black and white balance may be automatically checked and adjusted prior to the shoot. For example, one camera preset position may be chosen for framing and shooting a test or lineup chart prior to transmission. Adjustment of master pedestal, also known as master black level, detail, and red and blue gain is provided by graphical control sliders. Adjustment of any slider position may cause the slider to change its visual aspect, for example it may become grey, cross hatched or change color when the desired change is asserted and communicated to the camera. Having completed the value change the camera will signal the VCP and show compliance by causing the slider to revert to it's original quiescent visual aspect.

The MASTER PEDESTAL or master black level control of FIG. 4F is depicted as an analog slider which provides the full range of black level adjustment available in Camera 250. As the master black level slider is manipulated the GUI 320 program reads the new control slider position and converts it to an integer value. This integer value is encoded in a binary form, a control flag is set and the encoded binary value inserted in the next UDP packet scheduled for transmission via exemplary internet 150 to equipment 201 of studio 200. It should be noted that a backup modem connection via POTS 160 and dashed line 310A advantageously provides full VCP set up and operational control of studio 200 in the event of internet unavailability.

The remote communication process of SBC 202 receives the encoded value, decodes and checks the integer value for a value within a valid range. The value is then stored in a shared memory (SM) for access by the main process. In addition a flag is set to inform the main process that a change has been requested by VCP GUI 320. The main process reads the SM and processes the integer value. It is possible that the desired value change is not immediately actionable as a consequence of, for example, a calibration procedure, etc. However, when the main process permits, the integer value is accessed and the value written to another shared memory for access by the camera communication process.

The camera communication process constantly monitors changes in the shared memory and immediately a change in the black level value is detected the value is converted to an appropriate camera message which is then placed in the camera message queue as discussed previously. When the camera is ready/able to accept messages the queued messages are sent to the camera in accordance with their respective priority.

The camera process constantly sends current camera values and status back to the main process via the shared memory. Certain parameters, such as iris, focus, etc are polled from the camera on regular basis, others parameters are stored values determined by the last adjustment. The main process reads current camera parameter values from the camera shared memory and continuously writes them to the remote communication process shared memory. The actual camera settings are reported to the VCP GUI 320 by the remote communication process with the next UDP packet. This control and display process repeats continuously during manipulation of the slider graphical element. When manipulation ceases the graphical element reverts to an indicator function and displays the values reported from equipment 201 by the communication process.

Operation of the RETURN AUDIO control of FIG. 4G is explained with reference to an exemplary sequence shown in FIG. 6. The VCP operator starts the control sequence at block 500 by manipulation of the RETURN AUDIO graphical slider with the cursor, or the like, and causes the slider image or control lever to move to a new position. The GUI 320 program tests for a new slider position at decision block 510, with a NO entering a looping wait condition and YES causing the new slider position to be converted into a percentage value at block 515. The percentage value is encoded in binary form and a flag is set at block 520. At block 525 the encoded value and flag are inserted into the next UDP packet to be transmitted by block 530 via a network, for example, network 150 or POTS 160, to studio 200 and receiving block 535 of equipment 201.

The encoded value is checked at decision block 540 to determine if the percentage value is within a valid range. A YES at block 540 places the percentage value in shared memory SM, at block 545, where it is available to the main process. The YES also sets a flag in the shared memory informing the main process that a change has been requested by the virtual control panel GUI 320. If block 540 tests NO the percentage value is dumped (541) and no change occurs.

The SBC main process reads the percentage value from the shared memory at block 550 and processes it at block 555 to calculate an acoustic decibel (dB) value required for each audio signal (PROGRAM and IFB) to achieve the desired mix or balance. These calculated dB values are then written to another shared memory at block 560 and are available to the SBC hardware communication process.

The hardware communication process 570 constantly monitors for changes in shared memory block 565 and when detected, the dB values for each signal are recalculated to form smoothly changing multipliers for use by DSP 204. These values are sent to DSP 204 via microcontroller 220, which under normal operating conditions simply forwards the values to DSP 204, however as mentioned, in the event of SBC 202 reset or failure, microcontroller 220 can assume and maintain control of the user determined mix values. Digital signal processor DSP 204 receives the dB value message and effects a smooth signal amplitude change thus avoiding any audible distortion in the mixed signal.

Because the DSP 204 is controlled by mix values formed within the hardware process in response to values delivered by the main process, it is sufficient to report to the VCP the adjustments the main process ordered made. Current IFB and PROGRAM amplitude values are recalculated to percentage values and written to the remote communication process shared memory block 565. The remote communication process reads the shared memory and the settings are transported to the VCP and GUI 320 by the remote communication process with the next UDP packet (block 582) and transmission at block 590. UDP packet transmission is continuous with all display data transported to the VCP with a periodicity of between 50 to 1000 mille seconds.

Thus the percentage values provide updated control GUI status via receiving system block 594 and GUI graphic control 598 which changes the display in accordance with the received values. By reading shared memory, block 565, the main process and the communication process continuously provide the VCP with current values whether changed or not.

Transmission at block 590 includes not only control value feedback for the VCP but also includes the transmission output video and audio signals which are streamed to the VCP for operator control and monitoring. Typically, control adjustments are made with reference to the video image and, although control parameter values are necessary to verify control, most fine adjustments are carried out based on image observation. Consequently decision block 596 represents completion of the VCP operator control loop where a NO results in further operator manipulation of cursor and graphical element whilst a YES terminates the particular sequence of adjustment. When GUI manipulation ceases the graphical element reverts to an indicator function and displays the value reported from equipment 201 by the communication process. As noted previously a backup modem connection provides full VCP set up and operational control, however, output video monitoring may not be available.

The use of a graphic user interface generated by for example an applet received from the remote studio or a proprietary application provides an operator with the same degree of engineering control and production capability as that achieved in a conventional, real physical studio control room. However, applicants' advantageous remote controlled studio equipment and virtual control panel allow professional acquisition of live shots from any location having broadband network connectivity.

While various features and embodiments of the present invention have been described, it should be understood that these have been presented by way of example, and not limitation. It will be apparent to persons skilled in the relevant art that various changes in form and detail can be made therein without departing from the spirit and scope of the invention. Thus, the present invention should not be limited by any of the above described exemplary embodiments, but should be defined only in accordance with the following claims and their equivalents.

What is claimed is:

1. An audio video system comprising:
a video production studio generating a video signal;
a studio receiving said video signal from said production studio for broadcast propagation and, generating voice control messages for coupling to said video production studio; and,
a remote control panel coupled via a network to control equipment within said video production studio and to control said voice control messages received by said video production studio from said studio receiving.

2. The system of claim 1, wherein said remote control panel is a graphic user interface displayed on a personal computer and generated responsive to an applet received from said equipment within said video production studio.

3. The system of claim 1, wherein said remote control panel controls telephone dialing and telephone answering by said equipment within said video production studio.

4. The system of claim 1, wherein said remote control panel facilitates amplitude modification of said voice control messages received from said studio receiving.

5. The system of claim 1, wherein said remote control panel facilitates controllable mixing of said voice control messages received from said studio receiving with an audio signal generated within video production studio.

6. The system of claim 1, wherein said remote control panel facilitates controllable addition to said voice control messages received from said studio receiving, of a second voice control message received by said video production studio from a location other than said studio receiving.

7. The system of claim 1, wherein said remote control panel includes a display of said video signal from said production studio.

8. The system of claim 1, wherein said wherein said remote control panel includes a dynamic display of an audio signal generated within said production studio.

9. The system of claim 1, wherein said video production studio, said studio receiving and said remote control panel each have different geographic locations.

10. A method for obtaining control of an audio video studio comprising:
a) contacting to a network server and booking an audio video studio;
b) receiving an interne protocol address and key for said audio video studio;
c) contacting said audio video studio and receiving an applet defining a graphic user interface; and,
d) controlling said audio video studio with said graphic user interface.

11. The method of claim 10, wherein said element a) further comprises;
booking said audio video studio for a period of time; and,
terminating said booking when said period of time expires.

12. The method of claim 11, wherein said element c) further comprises;
inactivating said graphic user interface when said period of time expires.

13. The method of claim 11, further comprises;
contacting said audio video studio to approve or deny an extension of said period of time.

14. The method of claim 11, wherein said element b) further comprises;
coding said key to prevent use of said audio video studio outside said period of time.

15. The method of claim 10, wherein said element d) further comprises;
displaying said graphic user interface on a personal computer with one of a web browser and an application specific software.

16. A method for control, comprising:
forming a graphic user interface having graphical representations of control commands for equipment forming an audio video studio;
presenting said graphical representations in groups, wherein said groups include at least one of;
a first group representing a video camera control unit,
a second group representing controls for audio processing equipment
a third group representing interruptible feedback controls
manipulating one of said graphical representations and forming a control command signal for said equipment represented by said one of said graphical representations;
transmitting said control command signal to said audio video studio; and,
asserting said control command signal to control said equipment represented by said one of said graphical representations.

17. The method of claim 16 further comprises;
receiving from said equipment represented by said one of said graphical representations a signal indicating assertion of said control command signal;
changing a visual aspect of said manipulated graphical representation to indicate completion of said control command.

18. The method of claim 16, wherein said forming step further comprises;
including in said graphic user interface display areas representing one of a status display and an output video signal.

19. The method of claim 16, wherein said forming step further comprises;
including in said graphic user interface display an area having a dynamic representation responsive to a real time output audio signal level generated within said audio video studio.

20. The method of claim 16, wherein said manipulating step further comprises;
controlling a program audio signal level with said graphic user interface.

21. The method of claim 16 wherein said manipulating step further comprises;
controlling a mix of an interruptible feedback signal with a program audio signal using said graphic user interface.

22. The method of claim 16, wherein said manipulating step further comprises;
adjusting a program audio signal timing relative to a program video signal with said graphic user interface.

23. A remotely controlled audio video studio comprising:
a video camera;
an audio processing equipment; and,
an audio communication processing equipment;
wherein said video camera, said audio processing equipment and said audio communication processing equipment are coupled for control by digital signals formed by a central processing unit in response to signals received by a via a web server.

24. The studio of claim 23, further comprising; a computer displaying a graphic user interface, wherein said graphic user interface provides remote control of said video camera, said audio processing equipment and said audio communication processing equipment and facilitates monitoring on said graphic user interface of audio and video signals generated in said studio.

25. The studio of claim 24, wherein responsive to manipulation of graphical elements of said graphic user interface said digital signals are generated for coupling to said web server.

26. The studio of claim 25, wherein processing by said audio processing equipment and processing by said audio communication processing equipment is performed by a digital signal processor controlled responsive to manipulation of a graphical element representing one of an audio and communication parameter.

27. The studio of claim 24, wherein said graphic user interface is enabled for control of said studio by a key which sets a predetermined time interval.

28. An audio video studio comprising:
a camera,
microphone audio equipment, and,
digital equipment coupled to receive a video image signal from said camera and an audio signal from said microphone audio equipment for combining to form a first signal for transmission and a second signal for monitoring; and,
said video image signal and said audio signal exhibit a timing difference therebetween, wherein said digital equipment receiving said audio signal being controlled responsive to a digital control signal such that said audio signal is one of advanced and retarded in time relative to said video signal.

29. The audio video studio of claim 28, wherein said timing difference is substantially eliminated responsive to said digital control signal having a predetermined value corresponding to one of a type of said camera and manipulation of images formed thereby.

30. The audio video studio of claim 28, further comprising a computer receiving said second signal and having a graphic user interface display wherein manipulation of a graphical image part of said graphic user interface forms said digital control signal for coupling to adjust timing of said audio signal.

31. An audio video studio comprising:
a camera;
microphone audio equipment;
audio communications equipment;
digital equipment coupled to receive a video signal from said camera and a first signal from said microphone audio equipment and a second signal from said audio communications equipment; and,
said digital equipment being controlled responsive to a digital signal received from a network interface such that said first and second signals controllably form a single signal for coupling via said network interface to a monitoring location.

32. The audio video studio of claim 31, further comprising a computer at said monitoring location displaying a graphic user interface wherein manipulation of a graphical part of said graphic user interface forms said digital signal coupled to control amplitudes of said first and second signals.

33. The audio video studio of claim 32, wherein said graphical part of said graphic user interface represents a slider for determining a mixture of said first and second signals.

34. The audio video studio of claim 33, wherein said graphical part representing said slider changes a visual aspect to indicate completion of said amplitude control command.

35. A method for studio control, comprising:
forming a graphic user interface for controllably processing an interruptible feedback signal within said studio;
displaying a graphical representation of a button for muting said interruptible feedback signal within said studio;
generating a control command responsive to manipulating said graphical representation of said muting button;
coupling said control command signal to said studio; and,
muting said interruptible feedback signal by controlling said processing with said control command.

36. The method of claim 35, wherein said displaying step further comprises:
presenting a graphical representation of a fader for controlling an amplitude of said interruptible feedback signal within said studio.

37. The method of claim 35, wherein said displaying step further comprises:
showing a real time display of said interruptible feedback signal amplitude within said studio.

38. The method of claim 35, wherein said forming step further comprises, generating said graphic user interface on a personal computer coupled to said studio via a broadband network.

39. A method for video camera control, comprising:
receiving a control command and placing in a queue;
removing from said queue a prior duplicate of said control command;
asserting said control command in said video camera if execution is not conflicted;
rejecting said control command and replacing in said queue if execution is conflicted;
counting said rejection and reasserting said control command in said video camera until execution is not conflicted;
removing said control command from said queue responsive to a predetermined value of said counting;
generating a control value responsive to assertion of said control command; and,
communicating said control value for display.

40. The method of claim 39, further comprising:
forming said control command responsive to manipulation of a graphic user interface.

41. The method of new 5 further comprising:
receiving said control value for display in a graphic user interface.
